(19) United States
(12) Patent Application Publication
(10) Pub. No.: US 2009/0294999 A1
(43) Pub. Date: Dec. 3, 2009

(54) Method and Apparatus for Modifying an Index of Refraction Within a Material

(75) Inventors: Daniel B. Mitchell, Port McNicoll (CA); Geoffrey G. Harris, Midland (CA); Douglas J. Brown, Midland (CA)

Correspondence Address: HAYNES AND BOONE, LLP;IP Section, 2323 Victory Avenue, Suite 700, Dallas, TX, 75219, US

(73) Assignee: RAYTHEON COMPANY, Waltham, MA (US)

(21) Appl. No.: 12/129,437

(22) Filed: May 29, 2008

(51) Int. Cl. G02B 6/10

(52) U.S. Cl. 264/1.27

(57) ABSTRACT

A method includes: providing an element having mutually exclusive first and second portions with an initial index of refraction; and applying energy to the first portion in a manner causing the index of refraction thereof to change by at least 0.05 in relation to the index of refraction of the second portion. According to one specific approach, the applied energy is laser energy.

### FIELD OF THE INVENTION

This invention relates in general to techniques for forming optical structures and, more particularly, to techniques for modifying the index of refraction of one portion of a material relative to another portion thereof.

### BACKGROUND

Optical systems often use a waveguide to carry optical energy from one location to another. One technique for making a waveguide is to take a piece of glass or crystalline silicon, and focus ultra-fast laser pulses in an interior region. The laser energy induces a small change in the density of the material in the interior region, thereby changing the index of refraction of the interior region relative to the index of refraction of the remainder of the material. Although this pre-existing technique is interesting from an academic perspective, it has not been fully satisfactory in terms of practical application. For example, the maximum change to the index of refraction of glass or crystalline silicon is typically limited to about 0.01, or even less. A change this small limits the practicality of this pre-existing technique.

### BRIEF DESCRIPTION OF THE DRAWINGS

A better understanding of the present invention will be realized from the detailed description that follows, taken in conjunction with the accompanying drawing, in which:

FIG. 1 is a diagrammatic fragmentary perspective view of an apparatus that embodies aspects of the invention.

FIG. 2 is a graph showing the indexes of refraction exhibited by each of crystalline silicon and amorphous silicon within a selected range of wavelengths.

FIG. 3 is a diagrammatic fragmentary perspective view of an apparatus that is an alternative embodiment of the apparatus of FIG. 1, and that embodies aspects of the invention.

### DETAILED DESCRIPTION

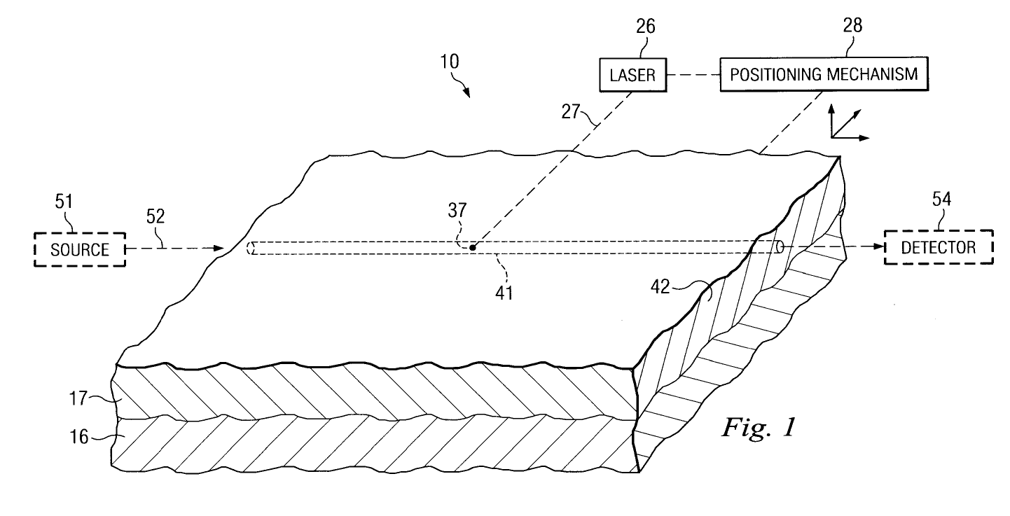

FIG. 1 is a diagrammatic fragmentary perspective view of an apparatus 10 that embodies aspects of the invention. The apparatus 10 includes a substrate 16 with an upper surface, and a coating or layer 17 of amorphous silicon provided on the upper surface of the substrate. The substrate 16 can be made of any material that is amenable to being coated with the amorphous silicon layer 17.

Infrared optical systems often use infrared radiation with a wavelength in the range of approximately 3 to 5 microns. Where amorphous silicon is to be used for infrared radiation in this range, the amorphous silicon can be produced with any desired index of refraction within a relatively wide range, from approximately 3.4 to approximately 3.8. Various techniques for depositing a layer of amorphous silicon are well known in the art. For example, several such techniques are disclosed in Palik, Handbook of Optical Constants of Solids, Academic Press, San Diego, Calif., 1998, pages 571-572. In FIG. 1, the amorphous silicon layer 17 is formed using a known technique, with an index of refraction that is about 3.8 and that is relatively uniform throughout the entire layer 17.

A laser 26 of a known type is provided. In the disclosed embodiment, the laser 26 is a commercially-available, chirped, pulse-amplified Ti:sapphire laser, shifted to a wavelength of 2400 nm. The laser produces a beam 27 in the form of a series of pulses, each pulse being about 70 fs long, and having an energy of about 600 μJ. A positioning mechanism 28 is provided, and can effect relative movement of the laser 26 in three dimensions with respect to the substrate 16 and the layer 17. The beam 27 of the laser 26 is focused at a point or region 37 located within the amorphous silicon layer 17, between the upper and lower surfaces of the layer 17. The 2400 nm wavelength of the laser 26 was selected because it can pass into the bulk of the silicon without being highly absorbed. In contrast, some other wavelengths of laser radiation would be highly absorbed by the silicon material.

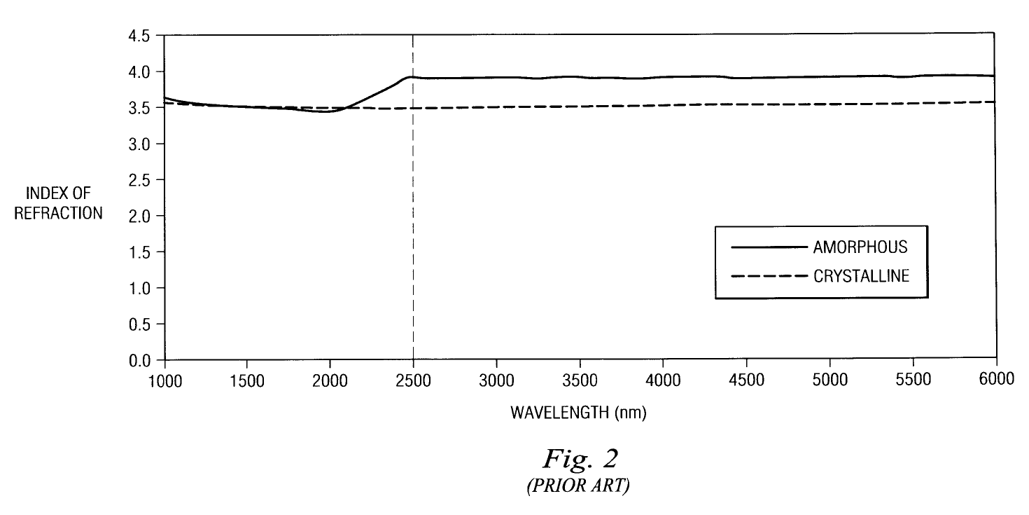

FIG. 2 is a graph showing the indexes of refraction exhibited by each of crystalline silicon and amorphous silicon within a selected range of wavelengths. It will be noted that, for wavelengths in the range of approximately 2500 nm to 6000 nm, crystalline silicon exhibits a relatively constant index of refraction of approximately 3.4, and amorphous silicon exhibits a relatively constant index of refraction of approximately 3.8. In FIG. 1, the laser energy focused at the point or region 37 causes a change in the physical structure of the amorphous silicon there. In particular, silicon atoms have a tendency to favor a crystalline structure, and the energy from the laser will tend to cause silicon material at the point or region 37 to shift from a purely amorphous state toward a crystalline state. This may produce a partially crystalline structure. For example, the laser radiation may cause many different portions of the silicon material to each have a crystalline structure, and to have random orientations with respect to each other. As silicon material at the point or region 37 shifts from an amorphous state toward a greater degree of crystallinity, the index of refraction changes relative to the rest of the amorphous silicon layer 17. The index of refraction can change by as much 0.4 or more.

While the laser 26 is producing the beam 27, the positioning mechanism 28 effects movement of the substrate 16 and the layer 17 relative to the laser 26, for example in a manner so that the point or region 37 where the laser beam is focused passes through all points within an elongate cylindrical portion 41 of the layer 17. This portion 41 is spaced below the top surface of the layer 17, and is spaced above the bottom surface of the layer 17. When this relative movement is completed and the laser 26 is turned off, the portion 41 of the layer 17 will have an index of refraction that is somewhat below the index of refraction of the remaining portion 42 of the layer 17. For example, the portion 41 may have an index of refraction of approximately 3.4, and the portion 42 may have an index of refraction of approximately 3.8. This difference in indexes of refraction permits the portion 41 to effectively function as the core of a waveguide, and permits the portion 42 to effectively function as the cladding of the waveguide. Thus, a conventional radiation source shown diagrammatically at 51 can supply a beam 52 of infrared radiation to one end of the portion 51, and this radiation can then propagate through the portion 41 to a conventional radiation detector shown diagrammatically at 54.

As explained above, the portions 41 and 42 of amorphous silicon layer 17 can each have the same initial index of refraction of about 3.8, and then laser energy can be applied to the portion 41 so as to reduce its index of refraction to about 3.4. Thus, the change in the index of refraction in the portion 41 is about 0.4, and this is about 40 times larger than the largest change in index of refraction achieved with pre-existing techniques. This significant improvement is due in part to the use of a different material in which the application of laser energy produces a change in crystalline structure, as well as a relatively large change in density.

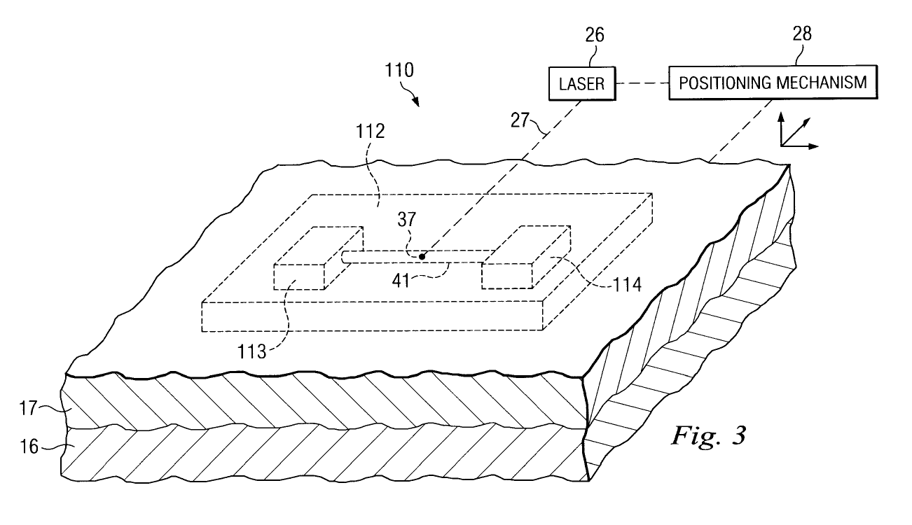

FIG. 3 is a diagrammatic fragmentary perspective view of an apparatus 110 that is an alternative embodiment of the apparatus 10 of FIG. 1, and that embodies aspects of the invention. The apparatus 110 of FIG. 3 is generally equivalent to the apparatus 10 of FIG. 1, except for differences discussed below. In FIG. 3, the amorphous silicon layer 17 contains an optical circuit that is indicated diagrammatically at 112. The optical circuit 112 can include various optical components, such as a radiation source 113, and a radiation detector 114. In a manner similar to that discussed above in association with FIG. 1, the laser 26 in FIG. 3 can be used to change the index of refraction of a portion 41 of the layer 17 that extends between the source 113 and the detector 114. The portion 41 can then serve as a waveguide. The laser 26 could also potentially be used to form portions of optical components, such as the source 113 or the detector 114.

In the disclosed embodiments, the layer 17 is made from amorphous silicon. However, the layer 17 could alternatively be made from any other suitable material that exhibits a significant change in its index of refraction in response to the application of energy such as laser radiation. For example, the layer 17 could be made from semi-amorphous silicon, aluminum oxide (Al₂O₃), yttrium oxide (Y₂O₃), titanium oxide (TiO₂), or indium-tin oxide (ITO). (ITO is a mixture of indium oxide (In₂O₃) and tin oxide (SnO₂), typically about 90% indium oxide and 10% tin oxide by weight). As still another alternative, the layer 17 could be made from a material that is made by Merck KGaA and that is commercially available as Substance H4, for example through EMD Chemicals Inc. of Gibbstown, N.J. Substance H4 is believed to include a mixture of titanium oxide (TiO₂) and lanthanum oxide (La₂O₃).

In the disclosed embodiments, laser energy is used to modify the index of refraction of an interior portion of a material relative to an outer portion thereof. Alternatively, however, it would be possible to modify the index of refraction of the outer portion relative to that of the interior portion.

A further consideration is that, in the embodiments discussed above, laser energy is used to modify a portion of a material by decreasing the index of refraction of that portion. Alternatively, however, it would be possible to use laser energy to increase the index of refraction of a portion of a material, for example by applying laser energy in a manner that tends to decrease rather than increase the degree of crystallinity.

Still another consideration is that, in the embodiments discussed above, laser energy is used to change the index of refraction of a portion of a material. Alternatively, however, it would be possible to utilize any other suitable technique that can modify the index of refraction of one portion of a material relative to another portion thereof.

Although selected embodiments have been illustrated and described in detail, it should be understood that a variety of substitutions and alterations are possible without departing from the spirit and scope of the present invention, as defined by the claims that follow.

What is claimed is:

1. A method comprising:
selecting a material in which the index of refraction can be within a range that is greater than 0.05;
providing an element that is made of said selected material, that has an initial index of refraction, and that has mutually exclusive first and second portions, one of said first and second portions being disposed around the other thereof, and said initial index of refraction being within said range and being relatively uniform throughout said first and second portions; and
applying energy to said first portion of said element in a manner causing the index of refraction thereof to change by at least 0.05 in relation to the index of refraction of said second portion.

2. A method according to claim 1,
wherein said selecting is carried out in a manner so that said range for said material is greater than 0.1; and
wherein said applying changes the index of refraction of said first portion by at least 0.1 in relation to the index of refraction of said second portion.

3. A method according to claim 2,
wherein said selecting is carried out in a manner so that said range for said material is greater than 0.2; and
wherein said applying changes the index of refraction of said first portion by at least 0.2 in relation to the index of refraction of said second portion.

4. A method according to claim 3,
wherein said selecting is carried out in a manner so that said range for said material is greater than 0.4; and
wherein said applying changes the index of refraction of said first portion by at least 0.4 in relation to the index of refraction of said second portion.

5. A method according to claim 1, including after said applying, using said element as a waveguide in a manner that includes causing radiation to propagate through said one of said first and second portions thereof.

6. A method according to claim 5, including selecting said first portion as said one of said first and second portions.

7. A method according to claim 1, wherein said selecting includes selecting as said material one of amorphous silicon, semi-amorphous silicon, aluminum oxide, yttrium oxide, titanium oxide, indium-tin oxide, and a mixture that includes indium oxide and tin oxide.

8. A method according to claim 1, wherein said applying is carried out in a manner that includes focusing laser energy in said first portion of said element.

9. A method according to claim 8, wherein said applying includes moving a region of focus of the laser energy within said first portion of said element.

10. A method according to claim 8, wherein said applying includes configuring said laser energy to include pulses that are approximately 70 fs long, that have an energy of approximately 600 μJ, and that have a wavelength of approximately 2400 nm.

11. A method comprising:
providing an element having integral first and second portions that are mutually exclusive, one of said first and second portions being disposed around the other thereof; and
applying laser energy to said first portion of said element in a manner causing the index of refraction thereof to change by at least 0.05 in relation to the index of refraction of said second portion.

12. A method according to claim 11, including configuring said element to contain at least one of amorphous silicon, semi-amorphous silicon, aluminum oxide, yttrium oxide, titanium oxide, indium-tin oxide, and a mixture that includes indium oxide and tin oxide.

13. A method according to claim 11, wherein said applying changes the index of refraction of said first portion by at least 0.1 in relation to the index of refraction of said second portion.

14. A method according to claim 13, wherein said applying changes the index of refraction of said first portion by at least 0.2 in relation to the index of refraction of said second portion.

15. A method according to claim 14, wherein said applying changes the index of refraction of said first portion by at least 0.4 in relation to the index of refraction of said second portion.

16. A method according to claim 11, including after said applying, using said element as a waveguide in a manner that includes causing radiation to propagate through said one of said first and second portions thereof.

17. A method according to claim 16, including selecting said first portion as said one of said first and second portions.

18. A method according to claim 11, wherein said applying includes moving a region of focus of the laser energy within said first portion of said element.

19. A method according to claim 11, wherein said applying includes configuring said laser energy to include pulses that are approximately 70 fs long, that have an energy of approximately 600 μJ, and that have a wavelength of approximately 2400 nm.
